(19) United States
(12) Patent Application Publication
(10) Pub. No.: US 2026/0311903 A1
(43) Pub. Date: Oct. 8, 2026

(54) DRY STORAGE CONTAINER FOR SPENT NUCLEAR FUEL WITH IMPROVED HEAT DISSIPATION EFFICIENCY OF DECAY HEAT

(71) Applicant: KOREA RADIOACTIVE WASTE AGENCY, Gyeongju-si Gyeongsangbuk-do (KR)

(72) Inventors: Seung Hyun KIM, Daejeon (KR); Hyungoo KANG, Daejeon (KR); Sang Hwan LEE, Daejeon (KR); Sang Hyuk YUN, Daejeon (KR); Yun Jung CHOI, Daejeon (KR); Tae Chul MOON, Daejeon (KR)

(21) Appl. No.: 19/479,148

(22) PCT Filed: Feb. 5, 2024
(86) PCT No.: PCT/KR2024/001642

§ 371 Date: Oct. 27, 2025

(30) Foreign Application Priority Data
Apr. 27, 2023 (KR) 10-2023-0055350

(51) Int. Cl. G21F 5/10; G21F 5/008; G21F 5/12

(52) U.S. Cl. CPC G21F 5/10; G21F 5/008; G21F 5/12

(57) ABSTRACT

The present invention relates to a dry storage container for spent nuclear fuel with improved heat dissipation efficiency of decay heat. The dry storage container for spent nuclear fuel with improved heat dissipation efficiency of decay heat has a plurality of protrusions formed on the outer surface thereof and can thus transfer heat with high efficiency to a buffer material installed on the outer surface thereof.

### CROSS REFERENCE TO RELATED APPLICATIONS

The present application is a U.S. National Phase of International Application No. PCT/KR2024/001642 entitled “DRY STORAGE CONTAINER FOR SPENT NUCLEAR FUEL WITH IMPROVED HEAT DISSIPATION EFFICIENCY OF DECAY HEAT”, and filed on Feb. 5, 2024. International Application No. PCT/KR2024/001642 claims priority to Republic of Korea Patent Application No. 10-2023-0055350 filed on Apr. 27, 2023. The entire contents of each of the above-listed applications are hereby incorporated by reference for all purposes.

### TECHNICAL FIELD

The present disclosure relates to a dry storage container for spent nuclear fuel with improved heat dissipation efficiency of decay heat, and more particularly, to a dry storage container for spent nuclear fuel with improved heat dissipation efficiency of decay heat that may dissipate heat by transferring heat to a buffer material in a highly efficient manner when the buffer material is installed on an outer peripheral surface thereof.

### BACKGROUND ART

A nuclear fuel refers to a material that is loaded into a reactor and causes a chain reaction of nuclear fission to obtain usable energy, while spent nuclear fuel refers to a material that remains after producing electricity.

The spent nuclear fuel may finally be disposed of permanently, typically by storing the spent nuclear fuel in a solid rock layer disposed at a depth of 500 to 1,000 meters underground. In addition, in order to permanently dispose of the spent nuclear fuel, the spent nuclear fuel may be accommodated in a storage container, and a buffer material may then be installed on an outer peripheral surface of the storage container to surround the outer peripheral surface of the storage container.

In this way, the buffer material installed on the outer peripheral surface of the storage container may perform a function of surrounding the outer peripheral surface of the storage container to prevent external groundwater or the like from penetrating into the interior of the storage container or adsorbing a radioactive material leaking from the storage container.

Meanwhile, the spent nuclear fuel may generate a large amount of heat, and the storage container that accommodates the spent nuclear fuel inside may thus deteriorate or the like by receiving the large amount of heat from the spent nuclear fuel. If the storage container breaks due to the deterioration or the like, the radioactive material may leak out of the storage container, thus causing a serious problem of radioactive contamination of a surrounding environment.

Therefore, in order to prevent the deterioration or the like of the storage container, it is necessary to develop a dry storage container that may dissipate heat by effectively transferring heat received from the spent nuclear fuel to the buffer material surrounding the outer peripheral surface of the storage container.

### DISCLOSURE

### Technical Problem

An object of the present disclosure is to provide a dry storage container for spent nuclear fuel that may effectively dissipate heat generated from the spent nuclear fuel.

Another object of the present disclosure is to provide a dry storage container for spent nuclear fuel that may prevent a buffer material, which is installed on an outer peripheral surface of the storage container, from being easily removed from the storage container.

Technical aspects of the present disclosure are not limited to those mentioned above, and other aspects not mentioned here may be clearly understood by those skilled in the art from the following description.

### Technical Solution

In one general aspect, provided is a dry storage container for spent nuclear fuel with improved heat dissipation efficiency of decay heat, the storage container including: a container including a lower surface formed at the bottom, a side surface, and a space capable of accommodating the spent nuclear fuel; a lid capable of sealing the space by being coupled to the top of the container and including an upper surface; and a plurality of protrusions protruding from at least one of the lower surface, the side surface, and the upper surface.

The plurality of protrusions may be disposed on the side surface, the side surface may include a first portion between the lid and a first point spaced apart from the lid by a first distance toward the lower surface, a second portion between the first point and a second point spaced apart from the first point by a second distance toward the lower surface, and a third portion between the second point and the lower surface spaced apart from the second point by a third distance toward the lower surface, and the plurality of protrusions may include a plurality of first protrusions disposed on the first portion and inclined downwards, a plurality of second protrusions formed in a cylindrical shape and disposed on the second portion, and a plurality of third protrusions disposed on the third portion and inclined upwards.

The second protrusion may be disposed on the second portion to have a line segment passing through a center of a cross-section of the second protrusion, the cross-section being perpendicular to a length direction of the second protrusion and the line segment being perpendicular to the side surface.

The second distance may be greater than a combined distance of the first distance and the third distance.

A length by which the plurality of second protrusions protrude vertically from the side surface may be greater than a length by which the plurality of first protrusions protrude vertically from the side surface or a length by which the plurality of third protrusions protrude vertically from the side surface.

The length by which the plurality of third protrusions protrude vertically from the side surface may increase from top to bottom.

The plurality of protrusions may include fourth protrusions disposed on the lower surface, and fifth protrusions disposed on the upper surface.

Each of the fourth protrusion and the fifth protrusion may be formed in a cylindrical shape.

The fourth protrusion may have a line segment passing through a center of a cross-section of the fourth protrusion, the cross-section being perpendicular to a length direction of the fourth protrusion and the line segment being perpendicular to the lower surface, and the fifth protrusion may have a line segment passing through a center of a cross-section of the fifth protrusion, the cross-section being perpendicular to a length direction of the fifth protrusion and the line segment being perpendicular to the upper surface.

Details of other embodiments are included in the description and drawings of the present disclosure.

### Advantageous Effects

According to the technical solution in the present disclosure described above, the dry storage container for spent nuclear fuel with improved heat dissipation efficiency of decay heat according to the present disclosure may effectively dissipate heat received from the spent nuclear fuel by increasing the area in contact with the buffer material.

In addition, the plurality of first protrusions may be disposed on the upper part of the side surface of the container and inclined downwards, thereby facilitating the installation of the buffer material on the dry storage container for spent nuclear fuel with improved heat dissipation efficiency of decay heat.

In addition, the plurality of third protrusions may be disposed on the lower part of the side surface of the container and inclined upwards, thus allowing the buffer material installed on the outer peripheral surface to be caught by the plurality of third protrusions, thereby preventing the buffer material from being easily removed from the dry storage container for spent nuclear fuel with improved heat dissipation efficiency of decay heat.

### DESCRIPTION OF DRAWINGS

FIG. 1 is a view showing a cross-section of a dry storage container for spent nuclear fuel with improved heat dissipation efficiency of decay heat according to an embodiment of the present disclosure.

FIG. 2 is a view showing an enlarged portion of A in FIG. 1.

FIG. 3 is a view showing an enlarged portion of B in FIG. 1.

FIG. 4 is a view showing an enlarged portion of C in FIG. 1.

FIG. 5 is a view showing an enlarged portion of D in FIG. 1.

FIGS. 6A and 6B are views for describing and comparing a contact area between a surface of a conventional dry storage container and a buffer material and a contact area between a surface of the dry storage container for spent nuclear fuel with improved heat dissipation efficiency of decay heat and a buffer material.

### Description of Reference Numerals

1: dry storage container for spent nuclear fuel with improved heat dissipation efficiency of decay heat
2: buffer material
100: container
110: lower surface
112: fourth protrusion
120: side surface
122: first portion
122-1: first protrusion
124: second portion
124-1: second protrusion
126: third portion
126-1: third protrusion
130: space
200: lid
210: upper surface
212: fifth protrusion

### BEST MODE

Hereinafter, an embodiment of the disclosure is described in detail with reference to the accompanying drawings so that those skilled in the art to which the disclosure pertains may easily practice the disclosure. However, the present disclosure may be modified in various different forms, and is not limited to the embodiments provided herein. In addition, in the drawings, portions unrelated to the description are omitted to clearly describe the present disclosure, and similar portions are denoted by similar reference numerals throughout the specification.

Throughout the specification, when one part is referred to as being “connected to” another part, one part and another part may be “directly connected to” each other, or may be “electrically connected to” each other with a third part interposed therebetween.

Throughout the specification, when one member is referred to as being disposed “on” another member, one member and another member may be in contact with each other, or a third member may be interposed between one member and another member.

Throughout the specification, “including” one component is to be understood to imply the inclusion of another component rather than the exclusion of another component, unless explicitly described to the contrary. As used throughout the specification, a term expressing degree such as “about”, “substantially”, or the like is used to indicate the number of a stated meaning or its approximation when its manufacturing or material tolerance inherent therein is given. Such a term is used to prevent unscrupulous infringers from unfairly using the present disclosure in which exact or absolute figures are stated to facilitate the understanding of this application. As used throughout the specification, a term such as a “step of (doing)” or a “step of~” does not indicate a “step for~”. Hereinafter, the embodiments of the present disclosure are described in detail with reference to the accompanying drawings and the descriptions provided below. However, the present disclosure is not limited to the embodiments described herein, and may also be embodied in another form. The same reference numerals denote the same components throughout the specification.

Hereinafter, the description describes a configuration of a dry storage container for spent nuclear fuel with improved heat dissipation efficiency of decay heat according to an embodiment of the present disclosure.

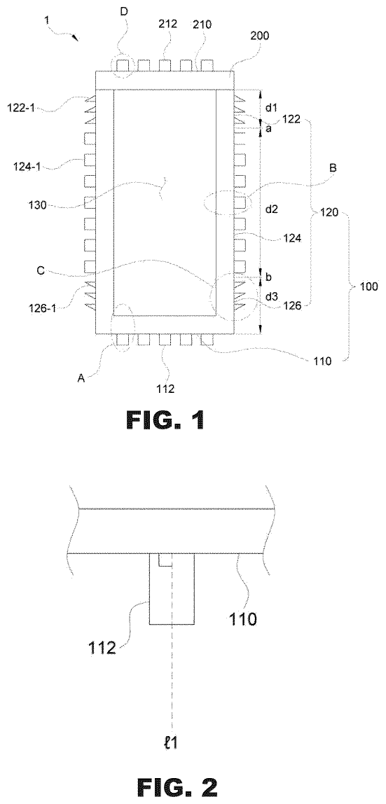

FIG. 1 is a view showing a cross-section of the dry storage container for spent nuclear fuel with improved heat dissipation efficiency of decay heat according to an embodiment of the present disclosure.

Referring to FIG. 1, the dry storage container for spent nuclear fuel with improved heat dissipation efficiency of decay heat may include a container 100 and a lid 200.

First, the description describes the container 100.

As shown in FIG. 1, the container 100 may include a lower surface 110, a side surface 120, and an open top to form a space 130 inside.

The lower surface 110 may be formed in various shapes, and also be formed in a circular shape. When the lower surface 110 is formed in the circular shape, the container 100 may be formed in a cylindrical shape having the circular lower surface 110.

In addition, as shown in FIG. 1, a plurality of fourth protrusions 112 may be disposed on the lower surface 110, and the fourth protrusion 112 may be formed in a cylindrical shape.

When the fourth protrusion 112 is formed in the cylindrical shape, the plurality of fourth protrusions 112 may be disposed on the lower surface 110 to have the largest possible surface area.

FIG. 2 is a view showing an enlarged portion of A in FIG. 1.

For example, as shown in FIG. 2, the fourth protrusion 112 may have a line segment 11 passing through the center of a cross-section of the fourth protrusion 112, the cross-section being perpendicular to a length direction of the fourth protrusion 112, and the line segment 11 being perpendicular to the lower surface 110.

The side surface 120 may extend upwards from the lower surface 110, and in a case where the container 100 is formed in the cylindrical shape, the cross section parallel to the lower surface 110 may be annular.

In addition, as shown in FIG. 1, the side surface 120 may have a plurality of protrusions disposed thereon.

In detail, as shown in FIG. 1, the side surface 120 may have a plurality of first protrusions 122-1 disposed on a first portion between the lid 200 and a first point a that is spaced apart from the lid 200 by a first distance d1 toward the lower surface 110.

Here, the plurality of first protrusions 122-1 may be inclined downwards.

In this way, when the plurality of first protrusions 122-1 are inclined downwards, a buffer material 2, such as bentonite, which is installed from the top toward the bottom of a dry storage container 1 for spent nuclear fuel with improved heat dissipation efficiency of decay heat, may be easily covered on the dry storage container 1 for spent nuclear fuel with improved heat dissipation efficiency of decay heat.

In addition, as shown in FIG. 1, the side surface 120 may have a plurality of second protrusions 124-1 disposed on a second portion between the first point a and a second point b spaced apart from the first point a by a second distance d2 toward the lower surface 110.

Each of the plurality of second protrusions 124-1 may be formed in a cylindrical shape. When the second protrusion 124-1 is formed in the cylindrical shape, the plurality of second protrusions 124-1 may be disposed on the side surface 120 to have the largest possible surface area.

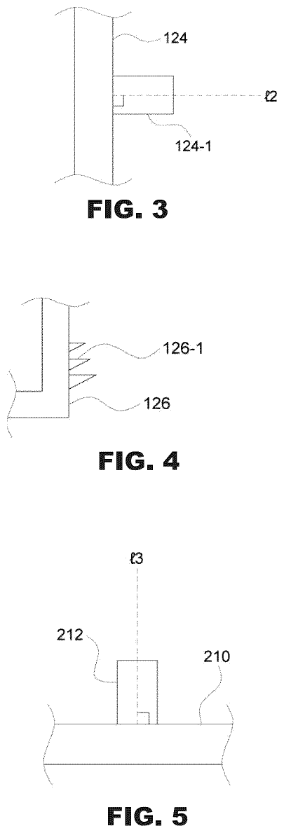

FIG. 3 is a view showing an enlarged portion of B in FIG. 1.

For example, as shown in FIG. 3, the second protrusion 124-1 may be disposed on the second portion to have a line segment 12 passing through the center of a cross-section of the second protrusion 124-1, the cross-section being perpendicular to a length direction of the second protrusion 124-1, and the line segment 12 being perpendicular to the side surface 120.

In addition, as shown in FIG. 1, the side surface 120 may have a plurality of third protrusions 126-1 disposed on a third portion between the second point b and the lower surface 110 spaced apart from the second point b by a third distance d3 toward the lower surface 110.

FIG. 4 is a view showing an enlarged portion of C in FIG. 1.

Here, the plurality of third protrusions 126-1 may be inclined upwards, and as shown in FIG. 4, a length by which the plurality of third protrusions 126-1 protrude vertically from the side surface 120 may each increase from top to bottom.

In this way, when the side surface 120 has the plurality of third protrusions 126-1 disposed thereon, the buffer material 2, which is installed on the dry storage container 1 for spent nuclear fuel with improved heat dissipation efficiency of decay heat, may be caught by the plurality of third protrusions 126-1, thereby preventing the buffer material 2 from being easily removed from the dry storage container 1 for spent nuclear fuel with improved heat dissipation efficiency of decay heat.

Meanwhile, the plurality of protrusions disposed on the side surface 120 may maximize their areas in contact with the buffer material 2 for efficient heat transfer to the buffer material 2.

For example, the second protrusion 124-1 formed in the cylindrical shape may have a greater surface area than that of the first protrusion 122-1 or the third protrusion 126-1, and the second protrusion 124-1 may be formed on the side surface 120 to occupy a relatively greater volume than that of the first protrusion 122-1 or the third protrusion 126-1.

In detail, the second distance d2, which is a length of the second portion where the second protrusion 124-1 is disposed, may be greater than a combined distance of the first distance d1, which is a length of the first portion where the first protrusion 122-1 is disposed, and the third distance d3, which is a length of the third portion where the third protrusion 126-1 is disposed.

In addition, the plurality of protrusions may be formed in such a way that a length by which the plurality of second protrusions 124-1 protrude vertically from the side surface 120 may be greater than a length by which the plurality of first protrusions 122-1 protrude vertically from the side surface 120 or a length by which the plurality of third protrusions 126-1 protrude vertically from the side surface 120.

The space 130 in the container 100 may accommodate the spent nuclear fuel inside.

Next, the description describes the lid 200.

The lid 200 may seal the space 130 by being coupled to the top of the container 100, and include an upper surface 210.

The lid 200 may be formed in various shapes, and if the container 100 is formed in a cylindrical shape, the lid 200 may also be formed in a circular plate shape.

Meanwhile, as shown in FIG. 1, a plurality of fifth protrusions 212 may be disposed on the upper surface 210 of the lid 200, and the fifth protrusion 212 may be formed in a cylindrical shape.

When the fifth protrusion 212 is formed in the cylindrical shape, the plurality of fifth protrusions 212 may be disposed on the upper surface 210 to have the largest possible surface area.

FIG. 5 is a view showing an enlarged portion of D in FIG. 1.

For example, as shown in FIG. 5, the fifth protrusion 212 may have a line segment 13 passing through the center of a cross-section of the fifth protrusion 212, the cross-section being perpendicular to a length direction of the fifth protrusion 212, and the line segment 13 being perpendicular to the upper surface 210.

Hereinafter, the description describes the operation and effect of the dry storage container 1 for spent nuclear fuel with improved heat dissipation efficiency of decay heat according to the present disclosure.

The buffer material 2 accommodating the spent nuclear fuel in the space 130 inside may be installed on the dry storage container 1 for spent nuclear fuel with improved heat dissipation efficiency of decay heat.

In detail, the buffer material 2 may be installed by being covered on the dry storage container 1 for spent nuclear fuel with improved heat dissipation efficiency of decay heat from the top toward the bottom.

Here, the plurality of first protrusions 122-1 may be inclined toward the bottom, and the buffer material 2 may thus be easily covered on the dry storage container 1 for spent nuclear fuel with improved heat dissipation efficiency of decay heat.

In addition, the buffer material 2, which is installed to surround an outer peripheral surface of the dry storage container 1 for spent nuclear fuel with improved heat dissipation efficiency of decay heat, may be caught by the plurality of third protrusions 126-1 inclined upwards and thus be effectively prevented from being removed from the dry storage container 1 for spent nuclear fuel with improved heat dissipation efficiency of decay heat.

Meanwhile, the plurality of protrusions may be disposed on the outer peripheral surface of the dry storage container 1 for spent nuclear fuel with improved heat dissipation efficiency of decay heat to widen a contact area between the dry storage container 1 for spent nuclear fuel with improved heat dissipation efficiency of decay heat and the buffer material 2, thereby improving heat dissipation efficiency of heat received from the spent nuclear fuel of the dry storage container 1 for spent nuclear fuel with improved heat dissipation efficiency of decay heat.

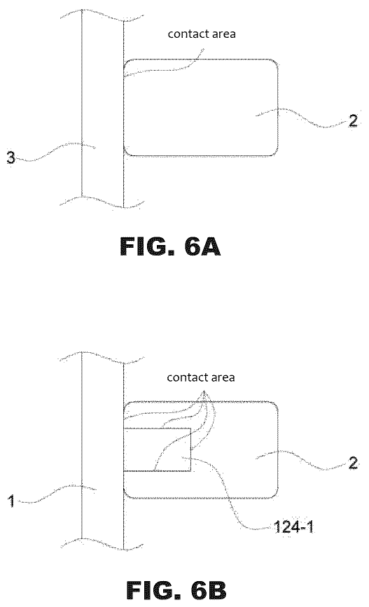

FIG. 6 is a view for describing and comparing a contact area between a surface of a conventional dry storage container and a buffer material and the contact area between the surface of the dry storage container for spent nuclear fuel with improved heat dissipation efficiency of decay heat and the buffer material.

In detail, as shown in FIG. 6, the contact area between the dry storage container 1 for spent nuclear fuel with improved heat dissipation efficiency of decay heat and the buffer material 2 (see FIG. 6B) may be greater than a contact area between a conventional dry storage container 3 and the buffer material 2 (see FIG. 6A) in which no protrusion is disposed on an outer peripheral surface.

Meanwhile, heat transferred from one object to another object may be transferred in a more highly efficient manner as a contact area between one object and another object increases. Accordingly, the dry storage container 1 for spent nuclear fuel with improved heat dissipation efficiency of decay heat, which has a larger contact area with the buffer material 2 than the conventional dry storage container 3, can dissipate heat by transferring heat to the buffer material 2 in a more highly efficient manner.

In this way, the dry storage container for spent nuclear fuel with improved heat dissipation efficiency of decay heat according to the present disclosure may effectively dissipate heat received from the spent nuclear fuel by increasing the area in contact with the buffer material.

In addition, the plurality of first protrusions may be disposed on the upper part of the side surface of the container and incline downwards, thereby facilitating the installation of the buffer material on the dry storage container for spent nuclear fuel with improved heat dissipation efficiency of decay heat.

In addition, the plurality of third protrusions may be disposed on the lower part of the side surface of the container and inclined upwards to thus allow the buffer material installed on the outer peripheral surface to be caught by the plurality of third protrusions, thereby preventing the buffer material from being easily removed from the dry storage container for spent nuclear fuel with improved heat dissipation efficiency of decay heat.

The above-described embodiments are illustratively provided, and it is apparent to those skilled in the art to which the present disclosure pertains that the present disclosure may be embodied in another specific form without any change in the technical idea or essential feature of the present disclosure. Therefore, it should be understood that the embodiments described above are illustrative rather than restrictive in all aspects. For example, the components that are each described as a single type may also be implemented in a distributed manner, and similarly, the components described as being distributed from each other may also be implemented in a combined manner.

It should be understood that the scope of the present disclosure is defined by the claims disclosed below rather than the detailed description provided above, and includes all alternations and modifications derived from the claims and their equivalents.

1. A dry storage container for spent nuclear fuel with improved heat dissipation efficiency of decay heat, the dry storage container comprising:
a container including a lower surface formed at a bottom of the container, a side surface, and a space capable of accommodating the spent nuclear fuel;
a lid capable of sealing the space by being coupled to a top of the container and including an upper surface; and
a plurality of protrusions protruding from at least one of the lower surface, the side surface, and the upper surface.

2. The dry storage container of claim 1, wherein the plurality of protrusions are disposed on the side surface,
wherein the side surface includes:
a first portion between the lid and a first point spaced apart from the lid by a first distance toward the lower surface,
a second portion between the first point and a second point spaced apart from the first point by a second distance toward the lower surface, and
a third portion between the second point and the lower surface spaced apart from the second point by a third distance toward the lower surface, and
wherein the plurality of protrusions includes:
a plurality of first protrusions disposed on the first portion and inclined downwards,
a plurality of second protrusions formed in a cylindrical shape and disposed on the second portion, and
a plurality of third protrusions disposed on the third portion and inclined upwards.

3. The dry storage container of claim 2, wherein a second protrusion of the plurality of second protrusions is disposed on the second portion such that a line segment passing through a center of a cross-section of the second protrusion is perpendicular to the side surface, the cross-section being perpendicular to a length direction of the second protrusion.

4. The dry storage container of claim 3, wherein the second distance is greater than a combined distance of the first distance and the third distance.

5. The dry storage container of claim 4, wherein a length by which the plurality of second protrusions protrude vertically from the side surface is greater than a length by which the plurality of first protrusions protrude vertically from the side surface or a length by which the plurality of third protrusions protrude vertically from the side surface.

6. The dry storage container of claim 5, wherein the length by which the plurality of third protrusions protrude vertically from the side surface increases from top to bottom.

7. The dry storage container of claim 6, wherein the plurality of protrusions include:
a fourth protrusion disposed on the lower surface, and
a fifth protrusion disposed on the upper surface.

8. The dry storage container of claim 7, wherein each of the fourth protrusion and the fifth protrusion is formed in a cylindrical shape.

9. The dry storage container of claim 8, wherein the fourth protrusion has a line segment passing through a center of a cross-section of the fourth protrusion, the cross-section being perpendicular to a length direction of the fourth protrusion and the line segment being perpendicular to the lower surface, and
wherein the fifth protrusion has a line segment passing through a center of a cross-section of the fifth protrusion, the cross-section being perpendicular to a length direction of the fifth protrusion and the line segment being perpendicular to the upper surface.
